(19) United States
(12) Patent Application Publication
(10) Pub. No.: US 2025/0378632 A1
(43) Pub. Date: Dec. 11, 2025

(54) DIFFUSION BASED END-TO-END IN-SCENE MEDIA GENERATION

(71) Applicant: REMBRAND, INC., Los Altos, CA (US)

(72) Inventors: Sameh KHAMIS, Alameda, CA (US); Abdelrahman Samir Abdelrahman MOHAMED, Redmond, WA (US); Ahmed Aly Saad AHMED, Bothell, WA (US)

(21) Appl. No.: 19/228,646

(22) Filed: Jun. 4, 2025

Related U.S. Application Data
(60) Provisional application No. 63/656,533, filed on Jun. 5, 2024.

(51) Int. Cl. G06T 15/50; G06T 7/20; G06T 7/70

(52) U.S. Cl. CPC G06T 15/506; G06T 7/20; G06T 7/70

(57) ABSTRACT

Embodiments of the present disclosure provide techniques for performing virtual object placement in a video sequence using generative artificial intelligence models. An example method generally includes receiving an input prompt specifying an object to insert into a scene depicted in an input image stream; decoding, using a generative artificial intelligence model, perspective and lighting information for the input image stream; determining, based on the decoded perspective and lighting information, a location in the scene in which the object is to be inserted; and generating, using the generative artificial intelligence model, an output image stream including the object into the scene at the determined location, wherein visual effects for the object are based on the perspective and lighting information for the input image stream.

### CROSS-REFERENCE TO RELATED APPLICATIONS

This application claims priority benefit of United States Provisional Patent Application titled “Diffusion Based End-to-End In-Scene Media Generation,” Ser. No. 63/656,533, filed Jun. 5, 2024. The subject matter of this related application is hereby incorporated herein by reference.

### BACKGROUND

### Field of the Various Embodiments

Embodiments of the present disclosure relate generally to visual effects, augmented reality, computer vision and, more specifically, to techniques for inserting objects into visual content using generative artificial intelligence models.

### Description of the Related Art

In the field of visual effects (VFX), virtual object placement refers to the insertion of one or more virtual objects into an existing video representation of a real-world scene, such as a recorded video sequence or a live video stream. Video creators may place virtual objects in a recorded video sequence, e.g., a movie or television program, for creative purposes or the like. Augmented reality (AR) systems may insert one or more virtual objects into a live video stream alongside real-world objects. For example, an augmented reality system may allow a user to insert virtual representations of home furnishings, decorations, or other objects into a live video stream of the user's living room to simulate an arrangement of objects without the need to procure and physically place the objects within the user's home.

Existing techniques for virtual object placement may rely on extensive manual manipulation, such as rotoscoping, where a creator manually traces around a depiction of an object in a still image or video sequence to create a matte, which is then inserted into a different still image or video sequence. Manual manipulation is time-consuming and requires significant skill. Further, manual manipulation methods may not account for lighting, atmospheric, or other environmental differences between scenes, resulting in an artificial or otherwise unnatural appearance for objects that have been extracted from one scene and placed into another scene.

Other existing techniques may automate portions of the object placement process, such as simple object extraction and placement. Similar to manual methods, these automated or semi-automated techniques may not address the environmental conditions into which the virtual object is to be placed, and may yield similarly unnatural results. Further, these techniques may provide few or no opportunities for user interaction during virtual object placement, and may require a trial-and-error approach involving numerous iterations with different configurations of user settings for each iteration, followed by a human evaluation of each iteration's results.

As the foregoing illustrates, what is needed in the art are more effective techniques for inserting objects into a scene depicted in a video sequence or other image stream.

### SUMMARY

One embodiment of the present invention sets forth techniques for performing virtual object placement in a video sequence using generative artificial intelligence models, the computer-implemented method including receiving an input prompt specifying an object to insert into a scene depicted in an input image stream; decoding, using a generative artificial intelligence model, perspective and lighting information for the input image stream, the generative artificial intelligence model comprising an autoregressive model conditioned based on a latent space representation of the input image stream generated by a foundation diffusion model and an adapter that configures the foundation diffusion model to generate an output including the object according to the perspective and lighting information for the input image stream; determining, based on the decoded perspective and lighting information, a location in the scene in which the object is to be inserted; and generating, using the generative artificial intelligence model, an output image stream including the object into the scene at the determined location, wherein visual effects for the object are based on the perspective and lighting information for the input image stream.

One technical advantage of the disclosed techniques relative to the prior art is that the disclosed techniques provide an end-to-end approach to virtual object placement using generative artificial intelligence models. The disclosed techniques automatically identify placement locations for a virtual object in a video sequence, where the placement locations are both physically suitable for the virtual object and contextually appropriate based on the semantic attributes of the scene, such as the optical properties of a system used to capture the scene depicted in the video sequence, motion of a camera during capture of the video sequence, lighting within the scene, and the like. The disclosed techniques may also automatically adjust the appearance of the virtual object to match the environmental conditions of the destination scene. Further, the disclosed techniques allow for realistic lighting and other optical effects to be applied to the scene and the virtual object inserted into the scene, thus resulting in the generation of realistic scenes including recorded and virtual objects. These technical advantages provide one or more improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments.

FIG. 2 is a representation of the data flow between various components of the present invention, according to some embodiments.

FIG. 3 represents a timeline including various components of the present invention, including input and output data associated with the various components, according to some embodiments.

FIG. 4 illustrates a pipeline for inserting objects into an input image stream based on a diffusion model and an autoregressive model, according to some embodiments.

FIG. 5 illustrates example operations for generating video content including an object inserted into an input video content based on a diffusion model and an autoregressive model, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

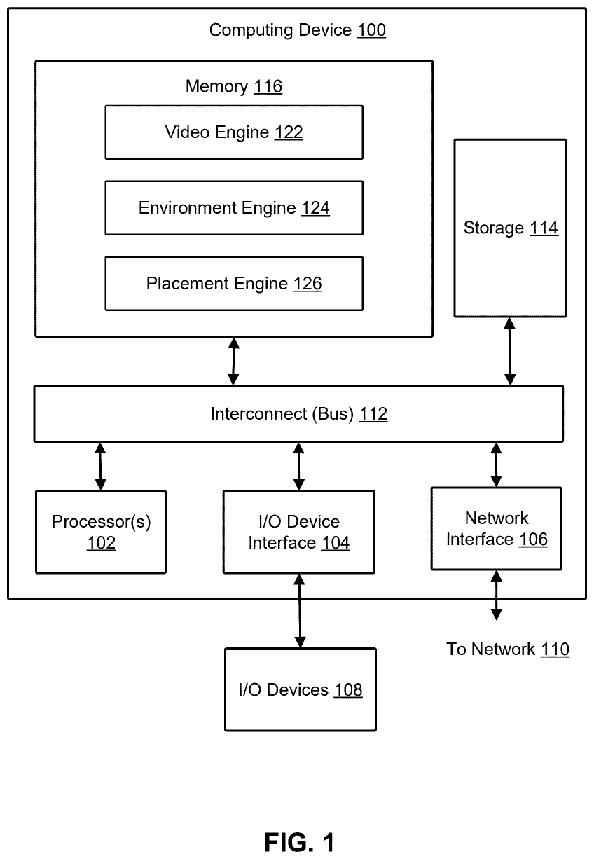

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a video engine 122, an environment engine 124, and a placement engine 126 that reside in a memory 116.

It is noted that the computing device described herein is illustrative and that any other technically feasible configurations fall within the scope of the present disclosure. For example, multiple instances of video engine 122, environment engine 124, and/or placement engine 126 could execute on a set of nodes in a distributed and/or cloud computing system to implement the functionality of computing device 100. In another example, video engine 122, environment engine 124, and/or placement engine 126 could execute on various sets of hardware, types of devices, or environments to adapt video engine 122, environment engine 124, and/or placement engine 126 to different use cases or applications. In a third example, video engine 122, environment engine 124, and/or placement engine 126 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Video engine 122, environment engine 124, and/or placement engine 126 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including video engine 122, environment engine 124, and/or placement engine 126.

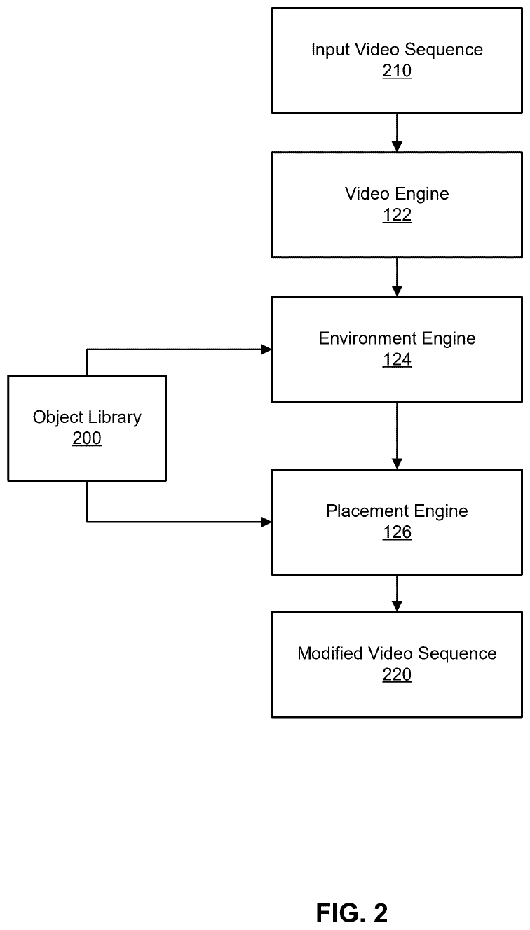

FIG. 2 is a representation of a data flow between various components of the present invention, according to some embodiments. As shown, the various components include, but are not limited to, video engine 122, environment engine 124, and placement engine 126. The present invention analyzes input video sequence 210 and generates modified video sequence 220, where modified video sequence 220 is augmented with one or more virtual objects included in object library 200.

In various embodiments, input video sequence 210 may include pre-recorded video content, such as a movie, television episode, or commercial advertisement. Input video sequence 210 may also include a real-time or near real-time video stream, such as a videoconferencing application, live video broadcasting application, or an augmented reality application. Input video sequence 210 includes multiple frames, where each frame includes a rectangular arrangement of pixels.

Video engine 122 analyzes input video sequence 210 and generates video metadata associated with input video sequence 210. Video engine 122 detects one or more shots and scenes included in input video sequence 210, where a shot is a sequential series of consecutive frames captured from a single fixed or moving camera viewpoint and a scene includes one or more shots portraying the same visual environment, room, or locale. Video engine 122 may also identify clusters of similar shots and clusters of similar scenes included in input video sequence 210.

For each shot included in input video sequence 210, video engine 122 may identify dynamic content included in the shot. For example, video engine 122 may identify moving entities such as doors, people, animals, or vehicles. For each frame included in a shot, video engine 122 may generate a two-dimensional (2D) mask associated with each moving entity that describes the pixels in the frame that are occupied by the entity.

Video engine 122 may also analyze the video or audio content included in input video sequence 210 and perform video or audio semantic analysis on the video or audio content. Based on the video or audio semantic analysis, video engine 122 generates semantic metadata associated with the shot, including a list of one or more objects included in the shot, a contextual description of the shot, or a semantic description of an environment or locale depicted in the shot. Video engine 122 generates video metadata associated with input video sequence 210 based on the identified and clustered shots and scenes, the identified dynamic content, and the video or audio semantic analysis.

Environment engine 124 analyzes shots and scenes included in input video sequence 210, estimates intrinsic and extrinsic parameters for one or more cameras associated with input video sequence 210, and analyzes objects and environments depicted in input video sequence 210. Environment engine 124 further calculates one or more suitability rankings based on one or more virtual objects included in object library 200 and one or more environmental surfaces identified in input video sequence 210.

For a shot included in input video sequence 210, environment engine 124 estimates intrinsic and extrinsic camera parameters associated with the shot. Intrinsic camera parameters may include a focal length associated with the camera, distortion data associated with the camera, or a principal point associated with the camera. Extrinsic camera parameters may include the camera's rotation, orientation, or movement during the video capture of the shot. The environment engine also calculates a comprehensive track of the camera's position during the shot, whether the camera is stationary or in motion.

For each frame included in a shot, environment engine 124 estimates a relative depth value for each pixel included in the frame. The relative depth values indicate whether a pixel is closer to or farther away from the camera compared to a different pixel. Based on the relative depth values, the disclosed techniques may determine whether an object to be inserted into a scene will be occluded (blocked) by one or more different objects included in the scene.

Environment engine 124 may also detect one or more planar surfaces included in a frame of input video sequence 210. Planar surfaces may include horizontal or vertical surfaces, such as a wall or the top surface of a desk. For each detected planar surface, environment engine 124 generates a polygon that defines the boundary of the planar surface and the pixels included in the planar surface. For each pixel included in a planar surface, environment engine 124 calculates a normal vector describing the orientation of the pixel.

Environment engine 124 may also identify one or more objects included in a frame and generate a three-dimensional (3D) bounding box associated with each object. Environment engine estimates physical dimensions for each identified object based on the 3D bounding boxes and the relative depth values for pixels included in the object.

Environment engine 124 further analyzes material properties associated with each identified planar surface in a frame, including roughness, albedo, and metallic or reflective properties. Environment engine 124 may analyze the lighting conditions depicted in a frame of input video sequence 210 and generate two-dimensional (2D) spatially varying light maps and 3D light maps that incorporate the relative depth values for pixels included in the frame. Environment engine 124 determines direct and indirect light sources illuminating the frame based on the generated light maps.

Environment engine 124 generates suitability rankings associated with combinations of virtual objects included in object library 200 and planar surfaces identified in a frame of input video sequence 210. Object library 200 may include depictions of one or more virtual objects and metadata associated with the one or more virtual objects. Metadata associated with a virtual object may include a name of the object, a textual description of the object, physical dimensions describing the object, or semantic terms associated with the object. For each combination of a virtual object and a planar surface, environment engine 124 generates a suitability ranking based on the size of the virtual object, whether or not the virtual object will be occluded by one or more other objects when placed on the planar surface, or whether the virtual object will be in focus. Environment engine 124 may also calculate a contextual suitability associated with a virtual object/planar surface combination based on semantic features associated with the virtual object and semantic features associated with a scene. For example, a virtual object that includes a framed photograph may be more contextually appropriate for placement on a desk or a wall than for placement on a bathroom sink. Environment engine 124 stores the calculated depth, surface, object, lighting, and suitability data for each scene as environment metadata.

Placement engine 126 augments input video sequence 210 with one or more virtual objects included in object library 200 and generates modified video sequence 220. Placement engine 126 includes an interactive user interface that allows a user to select one or more virtual objects from object library 200 and adjust the placement and appearance of the one or more virtual objects within a scene included in input video sequence 210. Placement engine 126 includes one or more machine learning models, such as rendering generators, diffusion generators, and discriminators. Placement engine 126 may automatically modify one or more parameters associated with the machine learning models based on a calculated adversarial loss. Placement engine 126 may present the one or more parameters to the user for further adjustment via virtual knobs, sliders, or other user interface controls. The automatic modification of the one or more machine learning model parameters provides realistic-appearing placement of virtual objects into a scene while still enabling manual user adjustment.

Placement engine 126 may further fine-tune one or more machine learning model parameters based on a user's historical preferences. Placement engine 126 may include a trained discriminator that distinguishes between augmented videos crafted by a specific user and augmented videos generated by a random user. The trained discriminator may also distinguish between augmented videos crafted by a specific user and videos that do not include virtual augmentation. Placement engine 126 adjusts the one or more machine learning model parameters based on an adversarial loss generated by the trained discriminator. These parameter adjustments ensure alignment with the current user's preferences, inferred from their past interactions and placements in historical videos. Placement engine 126 generates modified video sequence 220 that includes all or a portion of input video sequence 210 as modified via user interaction to include one or more virtual objects included in object library 200.

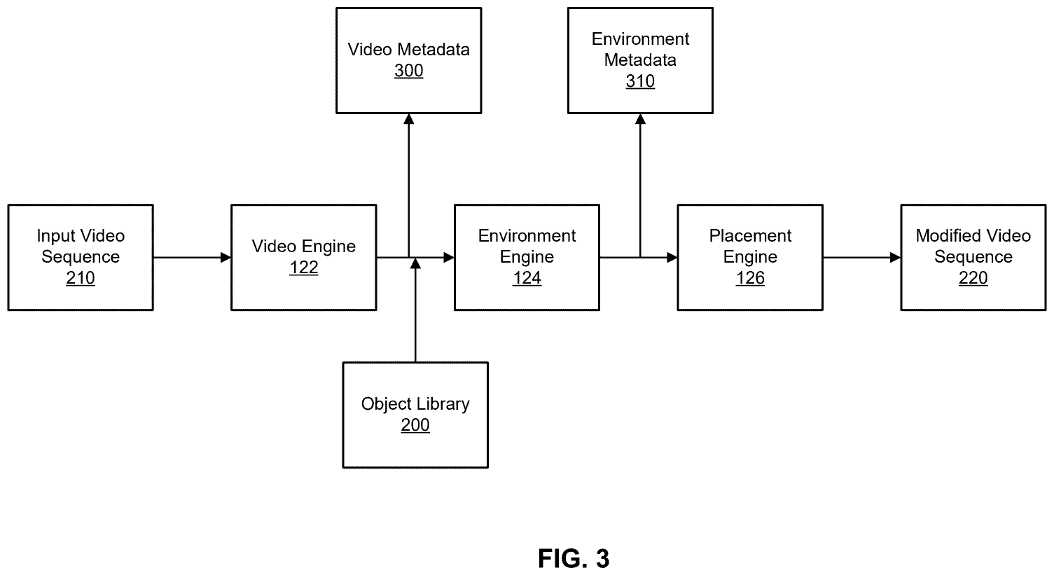

FIG. 3 represents a timeline including various components of the present invention, including input and output data associated with the various components, according to some embodiments. The output data includes, but is not limited to, video metadata 300, environment metadata 310, and modified video sequence 220.

Video engine 122 receives and analyzes input video sequence 210 to generate video metadata 300, including scene or shot clustering, dynamic content identification, and semantic information associated with input video sequence 210. Environment engine 124 analyzes one or more locales or environments included in input video sequence 210 and described in video metadata 300. Based on input video sequence 210, video metadata 300, and object library 200, environment engine 124 generates environment metadata 310, including estimated camera parameters, one or more depth maps, and analyses of the surfaces, objects, materials, or lighting conditions included in input video sequence 210. Placement engine 126 augments input video sequence 210 via the user-directed insertion of one or more virtual objects included in object library 200 into input video sequence 210. Placement engine 126 inserts the one or more virtual objects based on video metadata 300, environment metadata 310, user inputs, and one or more machine learning models. Placement engine 126 generates modified video sequence 220, where modified video sequence 220 includes all or a portion of input video sequence 210 as augmented with one or more virtual objects included in object library 200.

Generally, a video sequence or other image stream into which objects are inserted is captured by a camera with one or more lenses having defined optical properties. The camera and the one or more lenses may be defined, for example, based on a focal length of the one or more lenses, a corresponding field of view captured by the camera and one or more lenses (e.g., defined by the sensor size and focal length), and the like. The one or more lenses may impose various effects on the depiction of the scene in the captured video sequence or other image sequence, such as distortion, optical aberrations, out-of-focus effects (also known as bokeh), and the like. Further, the appearance of objects within the video sequence may be dependent on lighting effects in the scene, such as whether objects are illuminated by a point source or a diffuse lighting source, a color of the light source(s) illuminating the scene, and the like. Still further, different objects in a scene may impart visual effects on other objects in the scene; for example, an object with a reflective surface (e.g., water, metallic objects, etc.) may reflect the appearance of another object.

Inserting a virtual object into a scene depicted in a video sequence or image stream naively may result in the virtual object having an unrealistic appearance relative to other objects in the scene. When lighting effects are not considered in inserting an object in a scene, the inserted object may be rendered with different lighting effects than other objects in the scene. When perspective effects are not considered in inserting an object in a scene, the inserted object may appear unrealistically sized relative to other objects in the scene or may be rendered with a different degree of sharpness than other objects located at a similar depth in the scene relative to the camera used to capture the video sequence or image stream.

To allow for realistic and scene-consistent rendering of virtual objects inserted into a scene depicted in a video sequence or image stream, embodiments of the present disclosure use diffusion-controlled generative artificial intelligence models (e.g., language models) to extract information from a video sequence or image stream that can be used to influence how virtual objects are inserted into the scene. Generally, a diffusion model may include an encoder that encodes an input image stream into a latent space. The latent space representation of the input image stream may encode various attributes about the image stream, such as camera metadata (including intrinsic and extrinsic properties of the camera used to capture the input image stream) and environment metadata. The encoded version of the input image stream is then input into a language model as conditioning data for the language model to use in generating the placement location for a virtual object inserted into a scene depicted in the input stream. Finally, a diffusion decoder can decode the encoded versions of the input image stream and the location at which an object is to be inserted in the scene depicted in the input image stream to insert the object in a manner that is visually consistent with other objects in the scene.

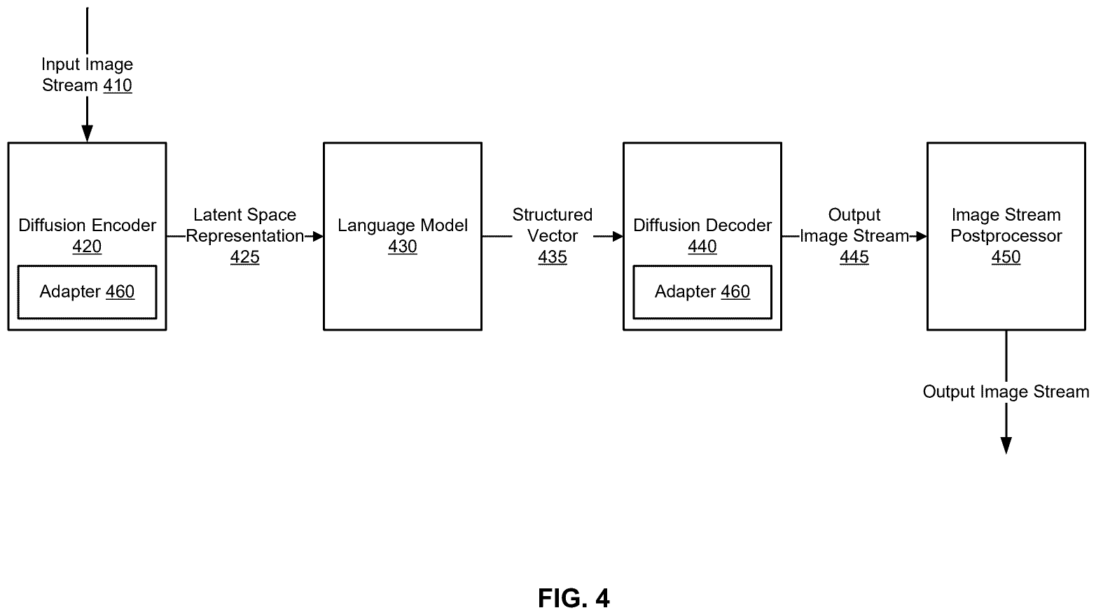

FIG. 4 illustrates a pipeline 400 for inserting objects into an input image stream based on a diffusion model and an autoregressive model, according to some embodiments. Pipeline 400 may be deployed across one or more of environment engine 124 and placement engine 126 illustrated in FIG. 1, according to some embodiments.

In the pipeline 400, diffusion encoder 420 and diffusion decoder 440 may be the encoder and decoder portions of a diffusion model trained to generate visual content from an input specifying the content to be generated. To allow for a diffusion model to provide conditioning data for a language model 430 to use in identifying positional, sizing, and visual appearance attributes of a virtual object inserted into a scene, the diffusion model may be defined as a foundational model and one or more adapters trained to generate an output image stream including an object specified for insertion into the scene depicted in the output image stream. Generally, a foundational model may be a generative artificial intelligence model that is trained on a wide variety of data sources to generate a wide variety of results (or, in other words, may be a generalist model). A foundational diffusion model may thus be a model trained to generate a wide variety of visual content by progressively denoising a noise distribution and may be adapted to perform the generation of visual content according to specific parameters.

To adapt the foundation model for generating visual content in which one or more objects are inserted into base visual content, the foundational diffusion model may be adapted using one or more adapters 460 to encode and decode the visual content including the one or more objects. For example, the one or more adapters 460 may be trained to encode and decode the visual content including the one or more objects based on perspective and lighting information for the input image stream. To generate the adapters 460, a synthetic data generation pipeline can be used to generate a training data set including a plurality of exemplars of image sequences and decomposition maps associated with each exemplar. The decomposition maps associated with an image sequence generally are representations of the image sequence including information defining perspective-invariant and perspective-variant data. Perspective-invariant data generally includes, for example, lighting information for a scene, the colors of objects in a scene, and other information about a scene and the objects depicted therein that do not vary based on the perspective from which the images in the image sequence are captured. Perspective-variant data generally includes, for example, shading or shadowing data for different objects in the scene, depth information associated with objects in the scene, camera focal length information, camera field of view information, and the like. Generally, the adapters 460 may be trained such that the input of perspective information and lighting information (amongst other perspective-invariant information that may be contemplated as inputs into a generative model) can be used to render an object in a manner that is consistent with the perspective from which the scene is captured and the lighting conditions depicted in the scene.

During inferencing, to insert a virtual object into a scene in a manner consistent with the perspective of the scene and the lighting conditions depicted in the scene, an input image stream 410 is input into the diffusion encoder 420 for processing. Generally, the diffusion encoder 420 (including one or more adapters 460, which may be associated with different layers or portions of the diffusion encoder 420) generates a latent space representation 425 of the input image stream 410. The latent space representation 425 encodes various information about the scene depicted in the input image stream 410, such as camera perspective parameters, object depth, and other information describing how the input image stream 410 was captured. Diffusion encoder 420 outputs the latent space representation 425 of the input image stream 410 to language model 430 for further processing. Generally, language model 430 ingests the latent space representation 425 of the input image stream 410 and extracts a structured vector 435 of numerical values associated with various perspective and lighting properties of the input image stream 410.

In some embodiments, the structured vector 435 may be defined as a sequence of numerical values separated by markers defining the start and end of different sub-sequences of numerical values. A first sub-sequence of numerical values may be defined for camera information, such as sensor size information, lens focal length information, sensor sensitivity, lens aperture, camera positioning within the environment in which the scene was captured, and other information defining the properties of the camera used to capture the input image stream 410. A second sub-sequence of numerical values may be defined for geometric data for different objects in the scene. A third sub-sequence of numerical values may be defined for the lighting information in the scene. In some embodiments, the lighting information may be defined as an environment map overlaid on images in the input image stream 410, with values of different segments of the environment map describing lighting arriving at a segment based on a spherical ball model for that segment. In some embodiments, the lighting information may be defined as a spherical Gaussian representation of light arriving at a point in a scene. Generally, the description of lighting arriving at a segment or point in a scene may account for light arriving from any direction and reflecting off of other objects in a scene.

In some embodiments, language model 430 may be a language model that uses any appropriate generative transformer architecture to generate a textual representation of data from an input prompt. In some embodiments, language model 430 may use mixed integer-floating point inputs in which tag tokens (e.g., associated with a type of data in a sequence) identifies a learned lookup table in the language model 430 and are associated with the integer portion of a value, while placement or other location data is associated with the floating point portion of that value. In some embodiments, language model 430 may be trained based on a loss directly applied between a predicted and ground-truth value for different types of data extracted from the latent space representation 425 of the input image stream 410. In some embodiments, language model 430 may be trained to generate the structured vector based on structured losses on individual fields, such as angles between normal vectors, quaternions for camera rotations, losses between predicted and ground-truth light maps describing the lighting in a scene, or the like.

The structured vector 435, along with information defining the object(s) to be inserted into the scene and the encoded version of the input image stream 410, may be input into diffusion decoder 440 for processing. Generally, diffusion decoder 440 may be conditioned to generate an output image stream 445 from the input image stream 410 including the objects defined for insertion in the scene in a manner that is consistent with the perspective and lighting captured in the input image stream 410. In some embodiments, diffusion decoder 440 may be conditioned to insert the objects into the scene conditioned based on a placement location defined for the objects and the latent space representation 425 of the input image stream 410. In such a case, diffusion decoder 440 (including one or more adapters 460) may insert the object into the scene at the placement location by denoising a patch added to the image stream 410 in which the object is to be included. Generally, because the adapters 460 adapt the diffusion decoder 440 to generate an image (e.g., via denoising) according to perspective and lighting information extracted from the input image stream 410, output image stream 445 includes the object in a manner that is consistent with camera perspective and environmental lighting.

In some embodiments, output image stream 445 may be post-processed by image stream postprocessor 450. Generally, image stream postprocessor 450 can add various effects to the output image stream 445 based, for example, on the reflectivity of the object added to the scene depicted in output image stream 445 and the reflectivity of other objects already extant in the scene. In some embodiments, image stream postprocessor 450 can add these effects to the output image stream 445 using ray-tracing techniques or other rule-based techniques that model visual interactions between different objects in a scene.

Generally, pipeline 400 executes autoregressively for each frame in an input image stream 410. That is, pipeline 400 may execute to insert an object into a first frame of input image stream 410. The modified first frame of input image stream 410 may be used as conditioning data for the modification of a second frame of input image stream 410, and so on.

Pipeline 400 may be configured to generate information for a single or multiple point placements. In generating information for multiple point placements, pipeline 400 may be configured, for example, to generate a plurality of maps at each generation step (e.g., for each frame). To do so, the language model 430 may be trained to generate a set of full maps sequentially based on a latent space map generated for a frame in an input image sequence. For example, language model 430 can generate a depth map, then use the depth map to produce a normal output, then use the normal output to generate material properties as output, then use the material properties to generate camera parameters, and finally, to use the camera parameters to generate a spherical Gaussian for the scene. In some embodiments, based on the spherical Gaussian generated for the scene, a plurality of smaller spherical Gaussians (e.g., associated with different objects in the scene) may be defined. In generating the corresponding frame for the output image stream 445, the pretrained layers of diffusion decoder 440 can decode depth, normal, and material latents, while adapter 460 may be used to decode the camera parameters and other output components. In some embodiments, pretrained layers of diffusion decoder 440 may also be used to decode the spherical Gaussians. In some embodiments, in generating information for multiple point placements, the diffusion decoder 440 can use positional encoding and decoding to define which inputs apply to the generation of image data for different positions in an image.

In some embodiments, pipeline 400 may be used to insert objects into image sequences captured using a moving camera or using Multiview (e.g., stereo imagery) techniques. To allow for the tracking of objects across frames, in such a case, language model 430 may take as input the coordinates of the object in one or more prior frames to determine the location of the object in a subsequent frame.

In some embodiments, one or more of video engine 122, environment engine 124, or placement engine 126 may allow for user feedback to be generated for the output image stream 445. The user feedback may be received, for example, via adjustment knobs, adjustment sliders, or other user interface elements that allow for feedback regarding the proper parameters used in generating the output image stream 445. After a user has completed adjustment of a generated output image stream, values for the user feedback may be extracted from the positional data associated with the user interface elements. The user feedback can subsequently be used to refine the adapters 460 to improve the quality of future image sequences generated using pipeline 400.

In some embodiments, pipeline 400 may execute server-side. In such a case, an input query specifying the object(s) to insert into a scene and the input image stream 410 may be received from a client device, and the generated output image stream 445 may be returned to the client device. In some embodiments, pipeline 400, or at least a portion of pipeline 400 (e.g., language model 430 and/or diffusion decoder 440) may execute client-side to minimize, or at least reduce, latencies involved in uploading content to a server for processing and receiving content from the server for display. When pipeline 400 or a portion thereof executes client-side, the decoding and generation of the output image stream 445 may be further conditioned based on user input, such as a cursor location or position in the scene clicked on by a user. For example, the position at which a user clicked on a scene may be used as conditioning data for the language model 430 and/or diffusion decoder 440 to use in determining the location at which an object is to be inserted into the scene and thus in generating the output image stream 445 based on decoding the encoded version 425 of the input image stream 410 and the structured vector 435.

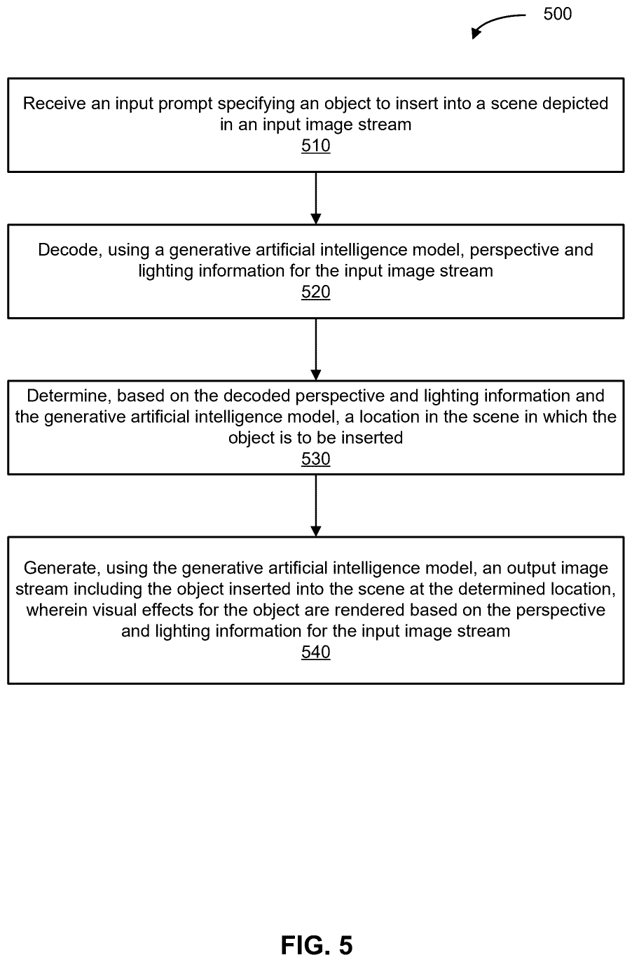

FIG. 5 illustrates example operations 500 for generating video content including an object inserted into an input video content based on a diffusion model and an autoregressive model, according to some embodiments. Operations 500 may be performed by a computing system on which video engine 122, environment engine 124, or placement engine 126 are deployed, such as the system 100 illustrated in FIG. 1.

As illustrated, operations 500 begin at block 510, where video engine 122 receives an input prompt specifying an object to insert into a scene depicted in an input image stream.

At block 520, operations 500 proceed with environment engine 124 decoding, using a generative artificial intelligence model, perspective and lighting information for the input image stream. Generally, the generative artificial intelligence model may include an autoregressive model conditioned based on a latent space representation of the input image stream generated by a foundation diffusion model and an adapter that configures the foundation diffusion model to generate an output including the object according to the perspective and lighting information for the input image stream.

In some embodiments, the perspective and lighting information comprise information about a camera used in capturing the scene, movement and positional information of the camera, and a description of lighting effects in the scene. The description of lighting effects in the scene may be, for example, an environment map in which each region in the map corresponds to a region in the scene and describes incoming light in a sphere associated with the region in the scene. In some embodiments, the description of lighting effects in the scene may be a spherical Gaussian representation of light arriving at different points in the scene.

In some embodiments, environment engine 124 can decode the perspective and lighting information for the input image stream based on generating, for each respective frame in the input image stream, one or more tokens representing the perspective and lighting information for the respective frame.

At block 530, operations 500 proceed with placement engine 126 determining, based on the decoded perspective and lighting information and the generative artificial intelligence model, a location in the scene in which the object is to be inserted.

In some embodiments, determining the location in the scene in which the object is to be inserted comprises determining a location for the object in a second frame in the input image stream based on a location for the object in a first frame in the input image stream and motion between the first frame and the second frame.

At block 540, operations 500 proceed with placement engine 126 generating, using the generative artificial intelligence model, an output image stream including the object inserted into the scene at the determined location. Generally, visual effects for the object are rendered based on the perspective and lighting information for the input image stream. In some embodiments, a first frame in the output image stream is further used to autoregressively condition an appearance of a second frame in the output image stream. That is, operations 500 may be repeated for each frame generated for a given input prompt and input image stream.

In some embodiments, generating the output image stream including the object includes determining a reflectivity of the object. Placement engine 126 and/or video engine 122 can render the object based on the reflectivity of the object, the lighting information, and other objects in the scene. The object may be rendered based on ray or path tracing between the object and other objects in the scene.

In some embodiments, generating the output image stream including the object comprises rendering the object and visual effects caused by the object on other objects in the scene.

One technical advantage of the disclosed techniques relative to the prior art is that the disclosed techniques provide an end-to-end approach to virtual object placement that allows for visually consistent object insertion in image data. The disclosed techniques use adapted diffusion models to extract information that is usable in determining the location at which an object is to be inserted, along with visual properties to apply to the object when inserted into a scene. By doing so, embodiments of the present disclosure allow for virtual objects to be inserted into a new scene such that the size, orientation, and other visual properties of an inserted virtual object meshes with the location at which an object is populated and the ambient lighting depicted in a scene. These technical advantages provide one or more improvements over prior art approaches.

### Example Clauses

Implementation details of various embodiments of the present disclosure are provided in the following numbered clauses:
1. In some embodiments, a computer-implemented method for performing virtual object placement in a video sequence, the computer-implemented method comprising: receiving an input prompt specifying an object to insert into a scene depicted in an input image stream; decoding, using a generative artificial intelligence model, perspective and lighting information for the input image stream, the generative artificial intelligence model comprising an autoregressive model conditioned based on a latent space representation of the input image stream generated by a foundation diffusion model and an adapter that configures the foundation diffusion model to generate an output including the object according to the perspective and lighting information for the input image stream; determining, based on the decoded perspective and lighting information and the generative artificial intelligence model, a location in the scene in which the object is to be inserted; and generating, using the generative artificial intelligence model, an output image stream including the object inserted into the scene at the determined location, wherein visual effects for the object are rendered based on the perspective and lighting information for the input image stream.
2. The method of clause 1, wherein a first frame in the output image stream is further used to autoregressively condition an appearance of a second frame in the output image stream.
3. The method of any of clauses 1 or 2, wherein the perspective and lighting information comprise information about a camera used in capturing the scene, movement and positional information of the camera, and a description of lighting effects in the scene.
4. The method of clause 3, wherein the description of lighting effects in the scene comprises an environment map, each region in the map corresponding to a region in the scene and describing incoming light in a sphere associated with the region in the scene.
5. The method of any of clauses 3 or 4, wherein the description of lighting effects in the scene comprises a spherical Gaussian representation of light arriving at different points in the scene.
6. The method of any of clauses 1 through 5, wherein inserting the object into the scene comprises autoregressively inserting the object into successive frames in the input image stream based on a location of the object in prior frames.
7. The method of any of clauses 1 through 6, wherein decoding the perspective and lighting information for the input image stream comprises generating, for each respective frame in the input image stream, one or more tokens representing the perspective and lighting information for the respective frame.
8. The method of any of clauses 1 through 7, wherein determining the location in the scene in which the object is to be inserted comprises determining a location for the object in a second frame in the input image stream based on a location for the object in a first frame in the input image stream and motion between the first frame and the second frame.
9. The method of any of clauses 1 through 8, wherein generating the output image stream including the object comprises: determining a reflectivity of the object; and rendering the object based on the reflectivity of the object, the lighting information, and other objects in the scene.
10. The method of clause 9, wherein the object is rendered based on path tracing between the object and other objects in the scene.
11. The method of any of clauses 1 through 10, wherein generating the output image stream including the object comprises rendering the object and visual effects caused by the object on other objects in the scene.
12. A processing system, comprising: at least one memory having executable instructions stored thereon; and one or more processors configured to execute the executable instructions to cause the processing system to perform the operations of any of clauses 1 through 11.
13. A processing system, comprising: means for performing the operations of any of clauses 1 through 11.
14. A non-transitory computer-readable medium having executable instructions stored thereon which, when executed by one or more processors, performs the operations of any of clauses 1 through 11.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A processor-implemented method, comprising:
receiving an input prompt specifying an object to insert into a scene depicted in an input image stream;
decoding, using a generative artificial intelligence model, perspective and lighting information for the input image stream, the generative artificial intelligence model comprising an autoregressive model conditioned based on a latent space representation of the input image stream generated by a foundation diffusion model and an adapter that configures the foundation diffusion model to generate an output including the object according to the perspective and lighting information for the input image stream;
determining, based on the decoded perspective and lighting information and the generative artificial intelligence model, a location in the scene in which the object is to be inserted; and
generating, using the generative artificial intelligence model, an output image stream including the object inserted into the scene at the determined location, wherein visual effects for the object are rendered based on the perspective and lighting information for the input image stream.

2. The method of claim 1, wherein a first frame in the output image stream is further used to autoregressively condition an appearance of a second frame in the output image stream.

3. The method of claim 1, wherein the perspective and lighting information comprise information about a camera used in capturing the scene, movement and positional information of the camera, and a description of lighting effects in the scene.

4. The method of claim 3, wherein the description of lighting effects in the scene comprises an environment map, each region in the map corresponding to a region in the scene and describing incoming light in a sphere associated with the region in the scene.

5. The method of claim 3, wherein the description of lighting effects in the scene comprises a spherical Gaussian representation of light arriving at different points in the scene.

6. The method of claim 1, wherein inserting the object into the scene comprises autoregressively inserting the object into successive frames in the input image stream based on a location of the object in prior frames.

7. The method of claim 1, wherein decoding the perspective and lighting information for the input image stream comprises generating, for each respective frame in the input image stream, one or more tokens representing the perspective and lighting information for the respective frame.

8. The method of claim 1, wherein determining the location in the scene in which the object is to be inserted comprises determining a location for the object in a second frame in the input image stream based on a location for the object in a first frame in the input image stream and motion between the first frame and the second frame.

9. The method of claim 1, wherein generating the output image stream including the object comprises:
determining a reflectivity of the object; and
rendering the object based on the reflectivity of the object, the lighting information, and other objects in the scene.

10. The method of claim 9, wherein the object is rendered based on path tracing between the object and other objects in the scene.

11. The method of claim 1, wherein generating the output image stream including the object comprises rendering the object and visual effects caused by the object on other objects in the scene.

12. A processing system, comprising:
at least one memory having executable instructions stored thereon; and
one or more processors configured to execute the executable instructions to cause the processing system to:
receive an input prompt specifying an object to insert into a scene depicted in an input image stream;
decode, using a generative artificial intelligence model, perspective and lighting information for the input image stream, the generative artificial intelligence model comprising an autoregressive model conditioned based on a latent space representation of the input image stream generated by a foundation diffusion model and an adapter that configures the foundation diffusion model to generate an output including the object according to the perspective and lighting information for the input image stream;
determine, based on the decoded perspective and lighting information and the generative artificial intelligence model, a location in the scene in which the object is to be inserted; and
generate, using the generative artificial intelligence model, an output image stream including the object inserted into the scene at the determined location, wherein visual effects for the object are rendered based on the perspective and lighting information for the input image stream.

13. The processing system of claim 12, wherein a first frame in the output image stream is further used to autoregressively condition an appearance of a second frame in the output image stream.

14. The processing system of claim 12, wherein the perspective and lighting information comprise information about a camera used in capturing the scene, movement and positional information of the camera, and a description of lighting effects in the scene.

15. The processing system of claim 12, wherein to insert the object into the scene, the one or more processors are configured to cause the processing system to autoregressively insert the object into successive frames in the input image stream based on a location of the object in prior frames.

16. The processing system of claim 12, wherein to decode the perspective and lighting information for the input image stream, the one or more processors are configured to cause the processing system to generate, for each respective frame in the input image stream, one or more tokens representing the perspective and lighting information for the respective frame.

17. The processing system of claim 12, wherein to determine the location in the scene in which the object is to be inserted, the one or more processors are configured to cause the processing system to determine a location for the object in a second frame in the input image stream based on a location for the object in a first frame in the input image stream and motion between the first frame and the second frame.

18. The processing system of claim 12, wherein to generate the output image stream including the object, the one or more processors are configured to cause the processing system to:
determine a reflectivity of the object; and
render the object based on the reflectivity of the object, the lighting information, and other objects in the scene.

19. The processing system of claim 12, wherein to generate the output image stream including the object, the one or more processors are configured to cause the processing system to render the object and visual effects caused by the object on other objects in the scene.

20. A non-transitory computer-readable medium having executable instructions stored thereon which, when executed by one or more processors, performs an operation comprising:
receiving an input prompt specifying an object to insert into a scene depicted in an input image stream;
decoding, using a generative artificial intelligence model, perspective and lighting information for the input image stream, the generative artificial intelligence model comprising an autoregressive model conditioned based on a latent space representation of the input image stream generated by a foundation diffusion model and an adapter that configures the foundation diffusion model to generate an output including the object according to the perspective and lighting information for the input image stream;
determining, based on the decoded perspective and lighting information and the generative artificial intelligence model, a location in the scene in which the object is to be inserted; and
generating, using the generative artificial intelligence model, an output image stream including the object inserted into the scene at the determined location, wherein visual effects for the object are rendered based on the perspective and lighting information for the input image stream.
